(19) United States
(12) Patent Application Publication
(10) Pub. No.: US 2022/0284382 A1
(43) Pub. Date: Sep. 8, 2022

(54) INVENTORY MANAGEMENT DEVICE

(71) Applicant: NTT DOCOMO, INC., Chiyoda-ku (JP)

(72) Inventors: Tsukasa DEMIZU, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/637,894

(22) PCT Filed: Aug. 25, 2020
(86) PCT No.: PCT/JP2020/031977

§ 371 Date: Feb. 24, 2022

(30) Foreign Application Priority Data
Aug. 30, 2019 (JP) 2019-158318

(51) Int. Cl. G06Q 10/08; G06Q 10/04; G06Q 30/02; G06N 20/00

(52) U.S. Cl. CPC G06Q 10/087; G06Q 10/04; G06Q 30/0202; G06N 20/00

(57) ABSTRACT

An inventory management device (1) includes an acquisition unit (11) that acquires a first learned model related to inventory management of old products, and relevance information related to relevance between the old products and new products, an assessment unit (14) that assesses whether or not the first learned model is applied to inventory management of the new products, based on the relevance information, and a determination unit (15) that applies the first learned model to the inventory management of the new products when the assessment unit (14) assesses that the first learned model is applied, and determines a policy for the inventory management of the new products.

### TECHNICAL FIELD

One aspect of the present invention relates to an inventory management device.

### BACKGROUND ART

In the related art, a system that optimizes inventory management in a flow of things (supply chain) from production to sales is known (see, for example, Patent Literature 1).

### CITATION LIST

### Patent Literature

[Patent Literature 1] Japanese Unexamined Patent Publication No. 2014-229252

### SUMMARY OF INVENTION

### Technical Problem

In inventory management, a scheme for formulating a stochastic programming problem or dynamic programming to determine an amount of orders (an amount of supply) is known. However, a scheme using such an exact solution method is not realistic in terms of an amount of calculation, for example, when a large supply chain is handled. On the other hand, it is difficult to guarantee prediction accuracy in a minimum unit such as a stock keeping unit (SKU) with a heuristic scheme such as performing calculation based on a moving average value. Accordingly, it is conceivable that it is not possible to perform the inventory management with high accuracy, and a cost increases due to opportunity loss or excess inventory. In particular, for example, when inventory management of newly released products for which a demand trend or a policy for the inventory management has not been determined is performed, it has been difficult to perform the inventory management with high accuracy.

One aspect of the present invention has been made in view of the above circumstances, and an object thereof is, for example, to perform inventory management with high accuracy in an approach of reinforcement learning.

### Solution to Problem

An inventory management device according to an aspect of the present invention includes an acquisition unit configured to acquire a first learned model related to inventory management of first products, and relevance information related to relevance between the first products and second products; an assessment unit configured to assess whether or not the first learned model is applied to inventory management of the second products, based on the relevance information; and a determination unit configured to apply the first learned model to the inventory management of the second products when the assessment unit assesses that the first learned model is applied, and determine a policy for the inventory management of the second products.

In the inventory management device according to an aspect of the present invention, it is assessed whether the first learned model related to the inventory management of the first products is applied to the inventory management of the second products based on the relevance information related to the relevance degree of the first products and the second products, and when it is assessed that the first learned model related to the inventory management of the first products is applied, the first learned model is applied to the inventory management of the second products. For example, it is difficult to perform inventory management of products for which the policy for the inventory management has not been determined, such as newly released products, with high accuracy at the beginning of release. Waiting for a release date of newly released products and newly learning a policy for inventory management requires application time. In order to appropriately perform inventory management of such products from the beginning of release, subjecting a policy related to inventory management of other products (a learned model) to transfer learning and applying the policy related to inventory management of other products is conceivable. However, since a demand trend or the like differs between respective products, it is conceivable that accuracy of the inventory management will worsen due to the transfer learning. In this regard, in the inventory management device 1 according to the present embodiment, since relevance between products (the first products) having the learned model related to inventory management and the second products is taken into account and it is assessed whether or not the learned model is applied to inventory management of the second products, for example, it is possible to curb the transfer learning between products with low relevance and, for example, to perform the transfer learning only between products with high relevance. Thus, it is possible to perform the inventory management of newly released products or the like with high accuracy from the beginning of release using the learned model by performing the transfer learning only between products that are expected to have matching demand trends or the like. Based on this, with the inventory management device according to an aspect of the present invention, it is possible to perform inventory management with higher accuracy as compared with the related art.

### Advantageous Effects of Invention

According to an aspect of the present invention, it is possible to perform inventory management with high accuracy.

### BRIEF DESCRIPTION OF DRAWINGS

FIG. 1 is a diagram illustrating an overview of an inventory management device according to an embodiment of the present invention.

FIG. 2 is a diagram illustrating a functional configuration of the inventory management device.

FIG. 3 is a diagram illustrating an example of relevance information.

FIG. 4 is a flowchart illustrating processing that is executed by the inventory management device.

FIG. 5 is a diagram illustrating a hardware configuration of the inventory management device.

### DESCRIPTION OF EMBODIMENTS

Hereinafter, embodiments of the present invention will be described in detail with reference to the accompanying drawings. In description of the drawings, the same or equivalent elements are denoted by the same reference numerals, and repeated description is omitted.

An inventory management device according to the present embodiment is, for example, a device that determines a product policy for inventory management in units of sales stores. The products here are products for which the policy for the inventory management has not been determined, such as new products. The inventory management policy is, for example, a policy such as an ordering timing according to an inventory quantity.

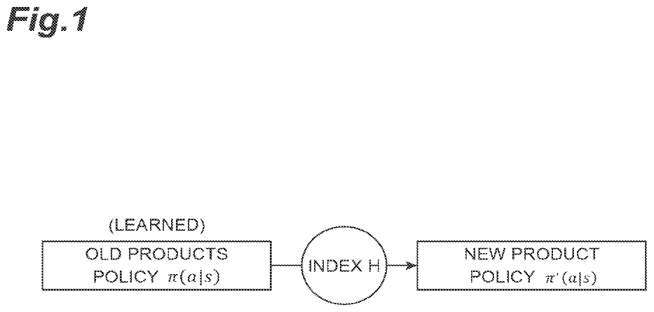

FIG. 1 is a diagram illustrating an overview of the inventory management device according to the present embodiment. The inventory management device according to the present embodiment, for example, assesses whether or not a learned policy π(a/s) of the old product (a product already being sold) is applied to the inventory management of the new products, based on a certain index H, and determines a policy π′(a/s) for inventory management of the new products based on the learned policy π(a/s) of the old product when the learned policy is applied. The policy π (or π′) here indicates a probability of action a being taken (only ΔΔ being ordered) in the case of a status s (for example, an inventory quantity is xx). In the inventory management device, the assessment as to whether or not the policy is applied is performed based on relevance between the old product and the new product. This makes it possible to apply the learned policy π(a/s) of the old product to the inventory management of the new products (perform transfer learning) only when the relevance between the old product and the new product is high, and to prevent a situation in which accuracy of the inventory management of the new products rather worsens due to the transfer learning. Hereinafter, a functional configuration of the inventory management device will be described in detail.

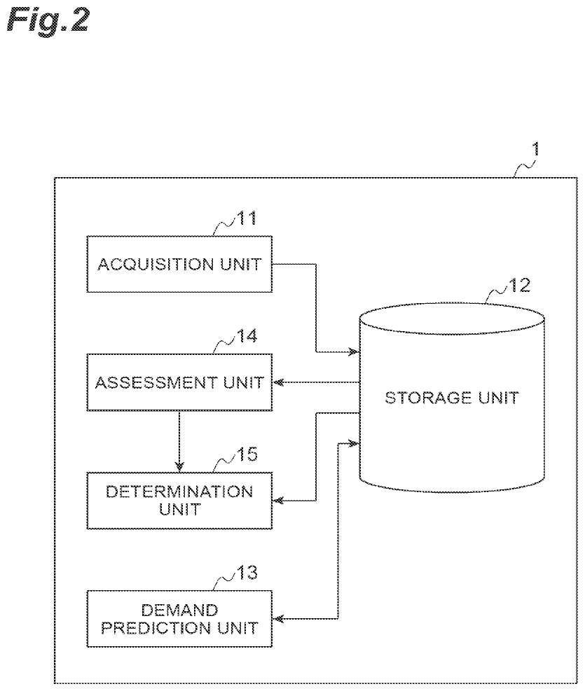

FIG. 2 is a diagram illustrating a functional configuration of the inventory management device 1. The inventory management device 1 may be a device that executes specific inventory management processing such as management of an inventory quantity and ordering by itself, or may be a device that does not execute the inventory management processing, but only functions related to “determination of a policy for inventory management” of the inventory management device 1 will be described in the present embodiment. The inventory management device 1 includes an acquisition unit 11, a storage unit 12, a demand prediction unit 13, an assessment unit 14, and a determination unit 15 as functional configurations thereof.

The acquisition unit 11 acquires a first learned model related to inventory management of the old product (a first product) and relevance information related to the relevance between the old product and the new product (a second product). The first learned model is a model related to derivation of the policy π(a/s) of the old product or the policy π(a/s) itself. The acquisition unit 11 may acquire the first learned model from, for example, an external device (not illustrated) or may acquire the first learned model in response to an input from a business operator who performs inventory management.

The acquisition unit 11 may acquire social networking service (SNS) data of each of the old product and the new product before a release date as the relevance information. The SNS data includes, for example, the number of transmissions regarding products using an SNS. The acquisition unit 11 acquires the SNS data from, for example, an external device (not illustrated) that manages the SNS data.

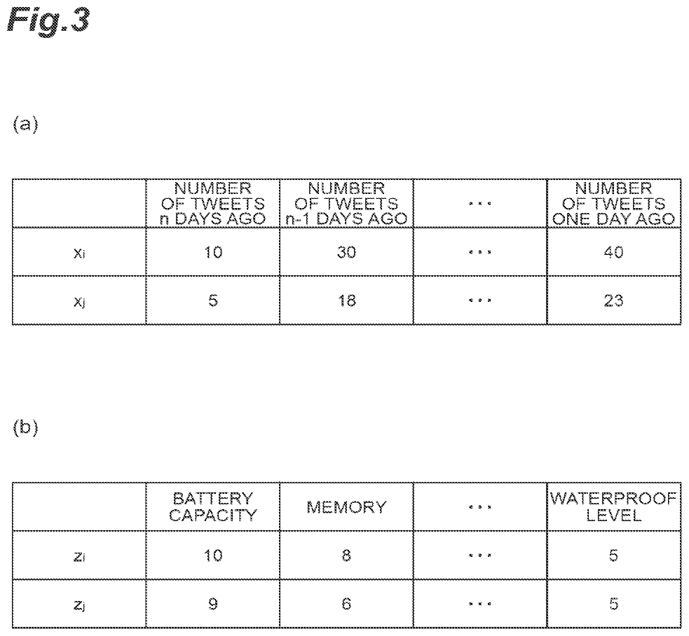

FIG. 3 is a diagram illustrating an example of the relevance information. FIG. 3(a) illustrates an example of the SNS data. In FIG. 3(a), the number of related tweets xi and xj for an old product i and a new product j from n days before a release date is illustrated. As illustrated in FIG. 3(a), for example, the number of related tweets n days before the release date of the old product i is xi=10, and the number of related tweets n days before the release date of the new product j is xj=5.

The acquisition unit 11 may acquire product features of the old product and the new product as the relevance information. For example, when the product is a smartphone, the product features include specifications such as a battery capacity, a memory, and a waterproof level. The acquisition unit 11 may acquire information on the product features from, for example, an external device (not illustrated) that manages product features or may acquire the information in response to an input from the business operator who performs inventory management.

FIG. 3(b) illustrates an example of product features when a product is a smartphone. In FIG. 3(b), vectors zi and zj regarding the product features of the old product i and the new product j are illustrated. The vectors zi and zj regarding the product features are values obtained by scoring evaluations of respective specifications (for example, a maximum of 10 points). As illustrated in FIG. 3(b), for example, a vector of battery capacity zi=10 for the old product i and a vector of battery capacity zj=9 for the new product j.

The acquisition unit 11 may acquire an inventory quantity of the old product at the time of (or before) release of the new product as the relevance information.

The acquisition unit 11 further acquires sales data of old products (third products) having high relevance to the new products. The old products (the third products) here may be the same products as the above-described old product (the first product) for which the policy π is derived by the first learned model, or may be different products from the above-described old product. The old products having high relevance to the new products are, for example, products having similar product features to the new products or products having the same model as the new products, which are products from one season ago. The sales data is information on the number of sold products in each sales time (elapsed time from the start of sales). For example, when the product is a smartphone, the acquisition unit 11 acquires daily sales data of the old products at a sales store that is a target for which a policy for inventory management is determined. When information is sparse only with sales data of the same products at the target sales store, the acquisition unit 11, for example, may increase a grain size of the products to a higher level and acquire sales data of the same products in different colors (products with a stock keeping unit (SKU)) or may increase a grain size of the store to a higher level and acquire sales data of multiple stores within the same mesh (area). The acquisition unit 11 may acquire the sales data from, for example, an external device (not illustrated) that manages sales data, or may acquire the sales data in response to an input from the business operator who performs inventory management. The acquisition unit 11 stores the various types of acquisition information described above in the storage unit 12. The storage unit 12 is a database that stores each piece of information acquired by the acquisition unit 11.

The demand prediction unit 13 constructs a demand prediction model for new products, based on sales data of the old products having high relevance to the new products. The demand prediction unit 13 acquires the sales data of the old products from the storage unit 12 and constructs the demand prediction model. The construction of the demand prediction model may be performed by, for example, machine learning well known in the past. The demand prediction unit 13 stores the constructed demand prediction model in the storage unit 12.

The assessment unit 14 assesses whether or not the first learned model is applied to the inventory management of the new products, based on the relevance information acquired by the acquisition unit 11. The assessment unit 14 outputs an assessment result to the determination unit 15.

The assessment unit 14 may assess that the first learned model is applied to the inventory management of the new products, for example, when the number of transmissions regarding the old product and the number of transmissions regarding the new product in the SNS data are similar to each other. Specifically, the assessment unit 14 sets a correlation coefficient Cor(xi, xj) between the number of related tweets regarding the old product and the number of related tweets regarding the new product as similarity D(i, j) between the old products and the new products based on the SNS data. When the similarity D(i, j) is equal to or larger than, for example, a threshold value D′ (for example, 0.7), the assessment unit 14 assesses that the number of transmissions regarding the old product and the number of transmissions regarding the new product are similar to each other and sales trends of the old products and the new products are similar to each other, and assesses that the first learned model is applied to the inventory management of the new products (the first learned model is used).

The assessment unit 14 may assess that the first learned model is applied to the inventory management of the new products when the product feature of the old product and the product feature of the new product are similar to each other. Specifically, the assessment unit 14 sets a correlation coefficient Cor(zi, zj) between the product feature of the old product and the product feature of the new product as the similarity D(i, j) based on the product feature. When the similarity D(i, j) is equal to or larger than, for example, the threshold value D′ (for example, 0.7), the assessment unit 14 assesses that the product feature of the old product and the product feature of the new product are similar to each other and the sales trends of the old products and the new products are similar to each other, and assesses that the first learned model is applied to the inventory management of the new products (the first learned model is used).

The assessment unit 14 may assess that the first learned model is applied to the inventory management of the new products when an inventory quantity of the old products at the sales store at the time of release of the new products is equal to or smaller than a predetermined threshold value. It is conceivable that initial sales of new products are affected by an inventory quantity of old products at the time of sales of the new products. For example, when the inventory quantity of the old products is large, a sales force of the old products remains and the initial sales of the new products fall. On the other hand, when the inventory quantity of the old products is small, it is conceivable that sales of the new products will be dominant.

When the assessment unit 14 assesses that the first learned model is applied to the inventory management of the new products, the determination unit 15 applies the first learned model to the inventory management of the new products, and determines the policy for the inventory management of the new products. For example, the determination unit 15 may set the policy π(a/s) for the old product derived from the first learned model as it is as the policy for inventory management of the new products.

For example, when a period of time elapses from the start of sales of the new products to some extent and the second learned model related to the inventory management of the new products has already been constructed, the determination unit 15 may combine the first learned model with the second learned model and determine the policy for the inventory management of the new products. That is, the determination unit 15 may combine the policy π(a/s) derived by the first learned model with a policy π″(a/s) derived by the second learned model and determine the policy π′(a/s) for the inventory management of the new products. The determination unit 15 may combine the first learned model with the second learned model and determine the policy π′(a/s) for inventory management of the new products so that a weight of the second learned model increases as the period of time elapses from the start of sales of the new products. In this case, an equation for derivation of the policy π′(a/s) for inventory management of new products is shown as Equation (1) below using a that gradually decreases (attenuates) over time.

π′(a/s)=α·π(a/s)+(1−α)·π″(a/s) (1)

The determination unit 15 may determine the policy for the inventory management of the new products in additional consideration of the demand prediction model of the new products constructed by the demand prediction unit 13. When the assessment unit 14 assesses that the first learned model is not applied to the inventory management of the new products, the determination unit 15 may determine the policy for the inventory management of new products based on only the demand prediction model without consideration of the first learned model.

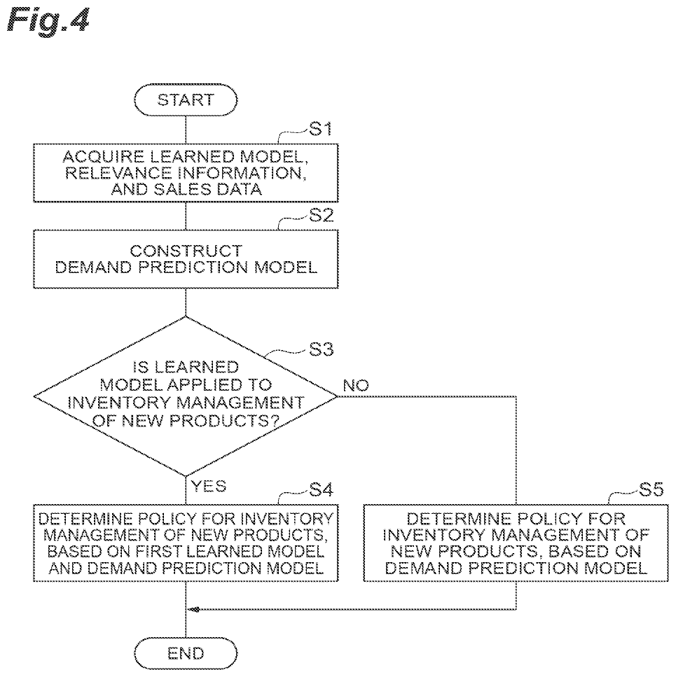

Next, processing that is executed by the inventory management device 1 will be described with reference to FIG. 4. FIG. 4 is a flowchart illustrating the processing that is executed by the inventory management device 1.

As illustrated in FIG. 4, the inventory management device 1 first acquires the first learned model related to inventory management of the old product, the relevance information related to the relevance between the old products and the new products, and the sales data of the old product having high relevance to the new product (step S1).

Subsequently, the inventory management device 1 constructs the demand prediction model for new products based on the above-described sales data (step S2).

Subsequently, the inventory management device 1 assesses whether or not the first learned model is applied to the inventory management of the new products (step S3). The inventory management device 1 assesses whether or not the first learned model is applied to the inventory management of the new products, based on the relevance information acquired by the acquisition unit 11. The inventory management device 1 may assess that the first learned model is applied to the inventory management of the new products, for example, when the number of transmissions regarding the old product and the number of transmissions regarding the new product in the SNS data are similar to each other. Further, the inventory management device 1 may assess that the first learned model is applied to the inventory management of the new products, for example, when the product feature of the old product and the product feature of the new product are similar to each other. Further, the inventory management device 1 may assess that the first learned model is applied to the inventory management of the new products, for example, when the inventory quantity of the old products at the sales store at the time of releasing the new product is equal to or smaller than a predetermined threshold value.

When it is assessed in step S3 that the first learned model is applied to the inventory management of the new products, the inventory management device 1 determines the policy for the inventory management of the new products, based on the first learned model (and the demand prediction model) (step S4). The inventory management device 1 may use the policy for the old products derived by the first learned model as it is as the policy for the new products, may determine the policy for the inventory management of the new products by combining the first learned model with the second learned model related to the inventory management of the new products, or may determine the policy for the inventory management of the new products from the first learned model and the demand prediction model.

On the other hand, when it is assessed in step S3 that the first learned model is not applied to the inventory management of the new products, the inventory management device 1 may determine the policy for the inventory management of the new products, based on the demand prediction model (step S5). Further, the inventory management device 1 may determine the policy for the inventory management of the new products, based on the second learned model or the second learned model and the demand prediction model after the second learned model related to the inventory management of the new products is constructed.

Next, an operation and effect of the inventory management device 1 according to the present embodiment will be described.

The inventory management device 1 according to the present embodiment includes the acquisition unit 11 that acquires the first learned model related to the inventory management of the old products and the relevance information related to the relevance between the old products and the new products, the assessment unit 14 that assesses whether or not the first learned model is applied to the inventory management of the new products, based on the relevance information, and the determination unit 15 that applies the first learned model to the inventory management of the new products when the assessment unit 14 assesses that the first learned model is applied, and determines the policy for the inventory management of the new products.

In the inventory management device 1 according to the present embodiment, whether the first learned model related to the inventory management of the old products is applied to the inventory management of the new products is assessed, based on the relevance information related to the relevance between the old products and the new products, and when it is assessed that the first learned model is applied, the first learned model is applied to the inventory management of the new products. It is difficult to perform inventory management of products for which the policy for the inventory management have not been determined, such as newly released products, with high accuracy at the beginning of release. In order to appropriately perform inventory management of such products from the beginning of release, it is conceivable that a policy related to inventory management of other products (a learned model) is subjected to the transfer learning and the policy related to inventory management of other products is applied. However, since a demand trend or the like differs between respective products, it is conceivable that accuracy of the inventory management rather worsens due to the transfer learning. In this regard, in the inventory management device 1 according to the present embodiment, since relevance between products (old products) having the learned model related to inventory management and new products is taken into account and it is assessed whether or not the learned model is applied to inventory management of the new products, for example, it is possible to curb the transfer learning between products with low relevance and, for example, to perform the transfer learning only between products with high relevance. Thus, it is possible to perform the inventory management of newly released products with high accuracy from the beginning of release using the learned model by performing the transfer learning only between products that are expected to have matching demand trends or the like. Further, a technical effect of reducing a processing load in a processing unit such as a CPU related to transfer learning is also achieved by performing transfer learning only between products that are expected to have a matching demand trend or the like. From the above, with the inventory management device according to an aspect of the present invention, it is possible to perform inventory management with higher accuracy as compared with the related art.

The determination unit 15 may determine the policy for inventory management for the new products by combining the first learned model with the second learned model related to the inventory management of the new products. Thus, it is possible to perform the inventory management with higher accuracy in consideration of the learned model of the new products themselves while using the first learned model that is an achievement, by not only simply applying the first learned model to the inventory management of the new products, but also determining the policy for inventory management of the new products in consideration of the second learned model related to the inventory management of the new products.

The determination unit 15 may determine the policy for inventory management of the new products by combining the first learned model with the second learned model so that the weight of the second learned model increases as a period of time elapses. Accordingly, a weight of the first learned model can be increased, for example, when the second learned model is not fulfilled at the beginning of release of the new products, and a weight of a learned model of new products can be increased after a period of time elapses since the release of the new products and the second learned model is fulfilled, and the policy for inventory management can be determined, for example. That is, it is possible to perform inventory management with high accuracy at any time by changing a learned model that is emphasized according to a time.

The acquisition unit 11 may acquire SNS data before a release date of the old products and the new products as the relevance information, and the assessment unit 14 assesses that the first learned model is applied to the inventory management of the new products when the number of transmissions regarding the old product and the number of transmissions regarding the new product in the SNS data are similar to each other. For example, it is assumed that the number of SNS transmissions before the release date is similar between products having high relevance of demand trends. Therefore, it is possible to apply the first learned model to the inventory management of the new products and to perform inventory management with higher accuracy when it is assumed that relevance of the demand trend is high, by applying the first learned model to the inventory management of the new products when the numbers of SNS transmissions before the release date of the old products and the new products are similar to each other.

The acquisition unit 11 may acquire the product features of the old products and the new products as the relevance information, and the assessment unit 14 may assess that the first learned model is applied to the inventory management of the new products when the product feature of the old product and the product feature of the new product are similar to each other. Products with similar product features are considered to have high relevance of demand trends. Therefore, it is possible to perform the inventory management with high accuracy by applying the first learned model to the inventory management of the new products when the product features of the old products and the new products are similar to each other.

The inventory management device 1 further includes the demand prediction unit 13 that constructs the demand prediction model for new products, based on the sales data of the old products having high relevance to new products, and the determination unit 15 may determine the policy for the inventory management of the new products in consideration of the demand prediction model. It is possible to perform the inventory management with higher accuracy while considering a demand trend by constructing the demand prediction model from similar products and determining the policy for the inventory management in consideration of the demand prediction model.

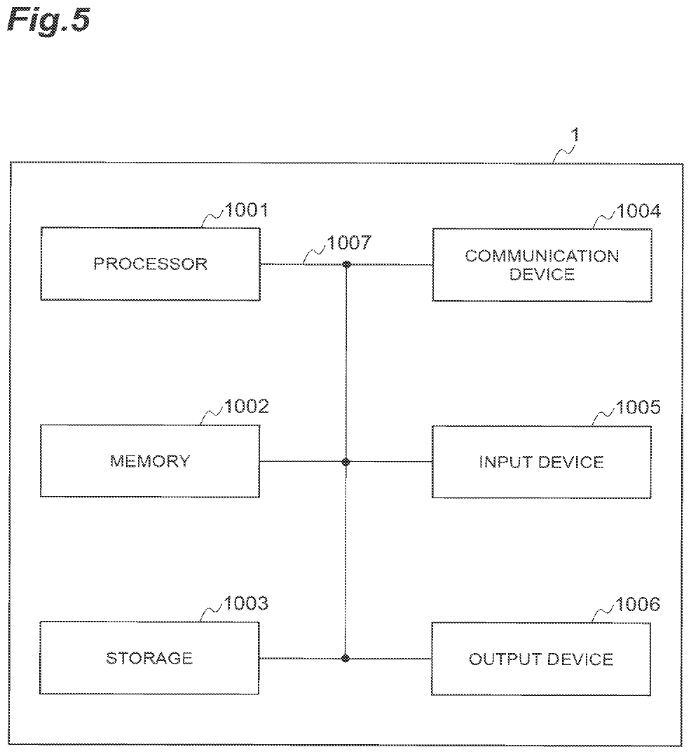

Finally, a hardware configuration of the inventory management device 1 will be described with reference to FIG. 5. The inventory management device 1 described above may be physically configured as a computer device including a processor 1001, a memory 1002, a storage 1003, a communication device 1004, an input device 1005, an output device 1006, a bus 1007, and the like.

In the following description, a word “device” can be read as a circuit, device, unit, or the like. The hardware configuration of the inventory management device 1 may be a configuration in which one or a plurality of devices illustrated in the figures are included, or may be a configuration in which some of the devices are not included.

Respective functions in the inventory management device 1 are realized by loading predetermined software (program) onto hardware such as the processor 1001 and the memory 1002 and the processor 1001 performing calculation to control communication using the communication device 1004 or reading and/or writing of data in the memory 1002 and the storage 1003.

The processor 1001 operates, for example, an operating system to control the entire computer. The processor 1001 may be configured of a central processing unit (CPU) including an interface with peripheral devices, a control device, a calculation unit, a register, and the like. For example, a control function of the assessment unit 14 or the like of the inventory management device 1 may be realized by the processor 1001.

Further, the processor 1001 reads a program (program code), a software module, or data from the storage 1003 and/or the communication device 1004 into the memory 1002, and executes various processing according to the program, the software module, or the data. As the program, a program that causes a computer to execute at least some of operations described in the above-described embodiment is used. For example, the control function of the assessment unit 14 or the like of the inventory management device 1 may be realized by a control program stored in the memory 1002 and operated by the processor 1001 or other functional blocks may be realized in the same manner. Although a case in which the various processing described above are executed by one processor 1001 has been described, the processing may be executed simultaneously or sequentially by two or more processors 1001. The processor 1001 may be mounted on one or more chips. The program may be transmitted from a network via a telecommunication line.

The memory 1002 is a computer-readable recording medium, and may be configured of at least one of a read only memory (ROM), an erasable programmable ROM (EPROM), an electrically erasable programmable ROM (EEPROM), and a random access memory (RAM). The memory 1002 may also be referred to as a register, a cache, a main memory (main storage device), or the like. The memory 1002 can store a program (program code), a software module, or the like that can be executed to implement a wireless communication method according to an embodiment of the present invention.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including the memory 1002 and/or the storage 1003, a server, or another appropriate medium.

The communication device 1004 is hardware (a transmission and reception device) for performing communication between computers via a wired network and/or a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 or the memory 1002 is connected by the bus 1007 for communicating information. The bus 1007 may be configured of a single bus or may be configured of different buses between devices.

Further, the inventory management device 1 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

Although the present embodiment has been described in detail above, it is apparent to those skilled in the art that the present embodiment is not limited to the embodiments described in the present specification. The present embodiment can be implemented as a modified and changed aspect without departing from the spirit and scope of the present invention defined by the description of the claims. Accordingly, the description of the present specification is intended for the purpose of illustration and does not have any restrictive meaning with respect to the present embodiments.

Each aspect or embodiment described in the present specification may be applied to long term evolution (LTE), LTE-Advanced (LTE-A), SUPER 3G, IMT-Advanced, 4G, 5G, future radio access (FRA), W-CDMA (registered trademark), GSM (registered trademark), CDMA2000, ultra mobile broad-band (UMB), IEEE 802.11 (Wi-Fi), IEEE 802.16 (WiMAX), IEEE 802.20, Ultra-Wide Band (UWB), Bluetooth (registered trademark), another system using an appropriate system, and/or a next generation system extended, based on these.

Processing procedure, flowchart, and the like in each aspect/embodiment described in the present specification may be in a different order unless inconsistency arises. For example, for the method described in the present specification, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

An assessment may be performed using a value (0 or 1) represented by one bit, may be performed using a Boolean value (true or false), or may be performed through a numerical value comparison (for example, comparison with a predetermined value).

Each aspect/embodiment described in the present specification may be used alone, may be used in combination, or may be used by being switched according to execution. Further, a notification of predetermined information (for example, a notification of “being X”) is not limited to being made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called other names.

Further, software, instructions, and the like may be transmitted and received via a transmission medium. For example, when software is transmitted from a website, a server, or another remote source using a wired technology such as a coaxial cable, an optical fiber cable, a twisted pair, or a digital subscriber line (DSL) and/or a wireless technology such as infrared rays, radios, or microwaves, the wired technology and/or the wireless technology is included in the definition of the transmission medium.

The information, signals, and the like described in the present specification may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

The terms described in the present disclosure and/or terms necessary for understanding of the present specification may be replaced by terms having the same or similar meanings.

Further, information, parameters, and the like described in the present specification may be represented by an absolute value, may be represented by a relative value from a predetermined value, or may be represented by corresponding different information.

A user terminal may be called a mobile communication terminal, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

The term “determining” used in the present disclosure may include a variety of operations. The “determining” can include, for example, regarding calculating, computing, processing, deriving, investigating, looking up (for example, looking up in a table, a database, or another data structure), or ascertaining as “determining”. Further, “determining” can include regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing, or the like as “determining”. That is, “determining” can include regarding a certain operation as “determining”.

The description “based on” used in the present specification does not mean “based only on” unless otherwise noted. In other words, the description “based on” means both of “based only on” and “at least based on”.

When the terms “first”, “second”, and the like are used in the present specification, any reference to elements thereof does not generally limit an amount or order of those elements. These terms can be used in the present specification as a convenient way to distinguish between two or more elements. Thus, the reference to the first and second elements does not mean that only two elements can be adopted or that the first element has to precede the second element in some way.

When “include”, “including” and modifications thereof are used in the present specification or claims, those terms are intended to be comprehensive like the term “comprising”. Further, the term “or” used in the present specification or claims is intended not to be an exclusive OR.

In the present specification, it is assumed that a plurality of devices are also included unless a single device is clearly indicated by the context or technically.

In the whole of the present disclosure, it is assumed that a plurality of things are included unless it is cleared from the context that a singular thing is indicated.

### REFERENCE SIGNS LIST

1 Inventory management device
11 Acquisition unit
13 Demand prediction unit
14 Assessment unit
15 Determination unit

1: An inventory management device comprising:
an acquisition unit configured to acquire a first learned model related to inventory management of first products, and relevance information related to relevance between the first products and second products;
an assessment unit configured to assess whether or not the first learned model is applied to inventory management of the second products, based on the relevance information; and
a determination unit configured to apply the first learned model to the inventory management of the second products when the assessment unit assesses that the first learned model is applied, and determine a policy for the inventory management of the second products.

2: The inventory management device according to claim 1, wherein the determination unit combines the first learned model with a second learned model related to the inventory management of the second products to determine the policy for the inventory management of the second products.

3: The inventory management device according to claim 2, wherein the determination unit combines the first learned model with the second learned model to determine the policy for the inventory management of the second products so that a weight of the second learned model increases as a period of time elapses.

4: The inventory management device according to claim 1,
wherein the acquisition unit acquires SNS data before a release date of the first products and the second products as the relevance information, and
the assessment unit assesses that the first learned model is applied to the inventory management of the second products when the number of transmissions regarding the first products and the number of transmissions regarding the second products in the SNS data are similar to each other.

5: The inventory management device according to claim 1,
wherein the acquisition unit acquires product features of the first product and the second product as the relevance information, and
the assessment unit assesses that the first learned model is applied to the inventory management of the second products when the product feature of the first product and the product feature of the second product are similar to each other.

6: The inventory management device according to claim 1, further comprising:
a demand prediction unit configured to construct a demand prediction model for the second products, based on sales data of third products having high relevance to the second products,
wherein the determination unit determines the policy for the inventory management of the second products in consideration of the demand prediction model.
